(19) United States
(12) Patent Application Publication
(10) Pub. No.: US 2006/0180205 A1
(43) Pub. Date: Aug. 17, 2006

(54) Drain valve for freight container

(76) Inventor: Wolf-Dietrich Gosch, Hamburg (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 11/337,830

(22) Filed: Jan. 23, 2006

(30) Foreign Application Priority Data
Jan. 22, 2005 (EP) 05001294.7

(51) Int. Cl. F16K 31/18

(52) U.S. Cl. 137/433

(57) ABSTRACT

A drain valve for installation in a floor has a generally tubular housing having an open upper end and an open lower end and laterally closed side walls therebetween. A bottom plate closing the lower housing end is formed with a throughgoing lower hole and is formed around the lower hole with an upwardly directed lower valve seat. A top plate closing the upper housing end is formed with a throughgoing upper hole and is formed around the respective hole with a downwardly directed upper valve seat. A floatable valve body in the housing between the plates is movable between an upper position fitted in and blocking the upper seat and clear of the lower seat and a lower position fitted in the lower seat and clear of the upper seat. Thus, flow only is possible through the housing in an intermediate position of the ball clear of both of the seats.

### FIELD OF THE INVENTION

The present invention relates to a drain valve. More particularly this invention concerns a drain valve that is fitted in a floor of a freight container, for instance a refrigerator car or the like.

Liquid resulting from condensation, melting, spills, and the like can collect on the floor of a freight container and cause considerable problems such as damaging the freight, causing accelerated spoilage, and mold generation. Accordingly U.S. Pat. No. 5,201,340 of Teepe describes a drain valve for installation in a floor comprising an outer tube adapted to be fitted through a floor and an inner tube engaged coaxially inside the outer tube and having an upwardly open upper end and a downwardly open lower end. A bottom plate closing the lower ends of both tubes is formed with a throughgoing lower hole and is formed around the lower hole with an upwardly directed lower valve seat. A top plate fitted to the upper housing end is formed with an array of holes over both the inner tube and the annular space between the inner and outer tubes. The inner tube is formed with an array of holes in its side wall. A floatable valve body in the housing between the plates can move up from a lower position fitted in and blocking the lower seat and clear of the upper seat to allow flow downward out of the container. Thus any liquid in the container will be able to flow down and into the valve, where it will float the valve body up to unlock the lower seat, allowing this liquid to flow out. Under normal circumstances, however, the valve body will block the lower hole and the valve will be closed.

Under some circumstances, water or another liquid can build up or pool underneath the container. This liquid can be the same liquid that drained out of the container but that has nowhere to go, or can come from another source, which is highly possible when the container are stored outside or on a ship deck. In this circumstance the liquid floats up the valve body so that the valve is open and the liquid can move up through the valve into the container.

Accordingly U.S. Pat. No. 6,131,605 proposes a system where underneath the above-described structure there is a second check-valve arrangement with a valve body that can float up and block from below the lower hole in the lower plate. In this manner flow back into the container is blocked. Such a valve is fairly long, so that it is difficult to fit in some floors or must be dimensioned to very close tolerances to fit. It is also rather complex and expensive to build, having two separate valve bodies that must be kept clean so they can move freely.

### OBJECTS OF THE INVENTION

It is therefore an object of the present invention to provide an improved freight-container drain valve.

Another object is the provision of such an improved freight-container drain valve that overcomes the above-given disadvantages, in particular that prevents liquid from entering the container from below through the valve while also being of simple and easy-to-service construction.

### SUMMARY OF THE INVENTION

A drain valve for installation in a floor has according to the invention a generally tubular housing having an open upper end and an open lower end and laterally closed side walls therebetween. A bottom plate closing the lower housing end is formed with a throughgoing lower hole and is formed around the lower hole with an upwardly directed lower valve seat. A top plate closing the upper housing end is formed with a throughgoing upper hole and is formed around the respective hole with a downwardly directed upper valve seat. A floatable valve body in the housing between the plates is moveable between an upper position fitted in and blocking the upper seat and clear of the lower seat and a lower position fitted in the lower seat and clear of the upper seat. Thus, flow only is possible through the housing in an intermediate position of the ball clear of both of the seats.

With this system therefore the same floating action that serves to open the valve when liquid enters it from above also serves to close the valve when it enters it from below, and only a single valve body can handle both functions. Only when there is a steady flow through the valve, with the valve body in an intermediate position because there is air above it, can there be flow through the valve. If the valve fills with liquid, it closes.

According to the invention the housing includes an outer tube adapted to be fitted through a floor and an inner tube engaged coaxially inside the outer tube, carrying the plates, and holding the body. A seal between the inner tube and outer tube blocks flow through the valve therebetween. Normally the outer tube, which can be identical to the outer tube of a conventional drain valve as described above with reference to U.S. Pat. No. '340, is fixed in the floor and the all of the other parts of the valve form a replaceable subassembly that, according to the invention, is releasably mounted in the outer tube.

More particularly in accordance with the invention the top plate has a radially projecting rim bearing on an inner surface of the outer tube and forming pert of the seal. Furthermore the inner tube has a lower end formed with a groove holding a seal ring bearing outward on an inner surface of the outer tube. This makes servicing, cleaning, and/or replacing the critical parts of the valve very easy. It also means that conventional valves can easily be replaced with double-action valves in accordance with the invention.

The top wall according to the invention is a disk snap-fitted to an upper end of the inner tube. It has perforations only in its center region above the open end of the inner tube, its rim being solid and imperforate to further block flow between an outer surface of the inner tube and an inner surface of the outer tube. Both tubes are laterally closed along their full lengths.

The small-diameter perforations are each of substantially smaller flow cross section than the upper hole. Furthermore the upper hole has a smaller flow cross section than the lower hole. In this manner even if the container floods badly internally, flow out of the valve will be faster than flow into the valve, preventing the valve body from floating up and blocking the upper hole. This is further ensured when according to the invention the perforations of the upper plate have a smaller aggregate flow cross section than the lower hole.

The valve body is a ball, but can also be lens shaped. Furthermore in accordance with the invention a strainer is fitted over the lower end of the housing.

### BRIEF DESCRIPTION OF THE DRAWING

The above and other objects, features, and advantages will became more readily apparent from the following description, reference being made to the accompanying drawing in which:

FIG. 1 is a vertical section through the valve according to the invention; and

FIG. 2 is a view showing the valve of FIG. 1 in a modified installation.

### SPECIFIC DESCRIPTION

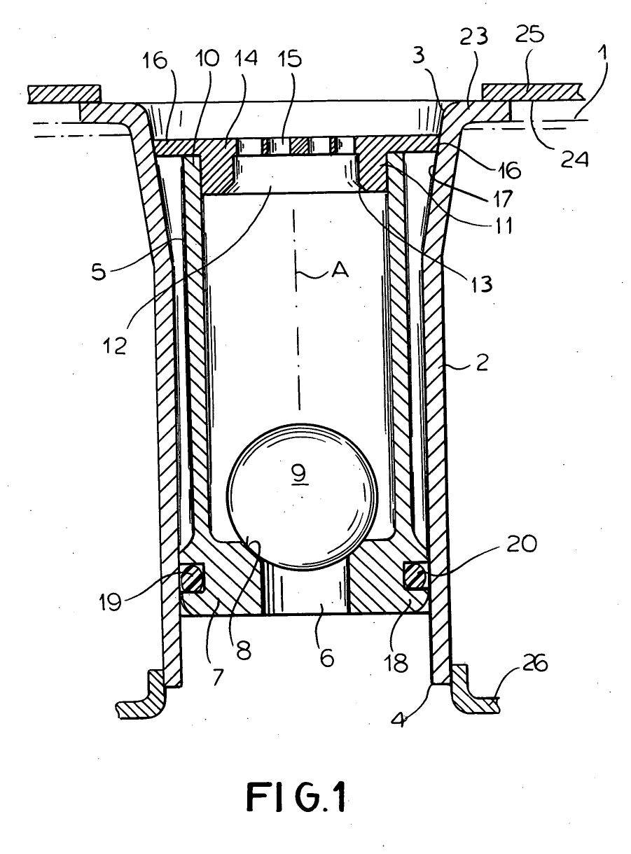

As seem in FIG. 1 a drain valve according to the invention is fitted in a freight-container floor 1 having a horizontal top plate or skin 25 and a horizontal bottom plate or skin 26, between which is normally provided unillustrated insulation. The container having the floor 1 must normally be protected against the entry or exit of air or gases from its interior, must also be able to automatically drain in the event water or another liquid gets on the floor, and must keep out any water or liquid it might be standing in or on.

The valve comprises an outer housing tube 2 centered on a normally vertical axis A and having an upwardly open and flared frustoconical upper and 3 and a cylindrical and downwardly open lower end 4. An inner housing tube 5 is coaxially received in the outer tube 2 and has a lower wall or floor 7 formed with cylindrical central throughgoing lower hole or aperture 6. A frustoconical lower seat 8 formed at the upper side of the hole 6 fits with a circular ball float 9 forming a valve body. A lip 18 of the lower wall 7 forms a radially outwardly open annular groove 19 holding an O-ring 20 so that no flow is possible axially through the valve between the tubes 2 and 5. In addition the tight fit of the O-ring 20 holds the inner tube 5 solidly in the outer tube 2 while still allowing it to be removed for replacement, servicing, or cleaning.

Fitted to an upwardly open end 10 of the inner housing tube 5 is a top plate or cover disk 11 formed with a central downwardly open upper hole 12 whose edge 13 forms an upper seat like the lower seat 8. A web 15 of the plate 11 forms its upper surface 14 and is in turned formed with an array of throughgoing holes or perforations 21 aligned with the upper hole 12. A radially outwardly projecting rim 16 of the top plate 11 engages the frustoconically upwardly flared inner surface 17 of the outer tube 2, further securing the inner tube 5 in the outer tube 2 and blocking flow between these tubes 2 and 5.

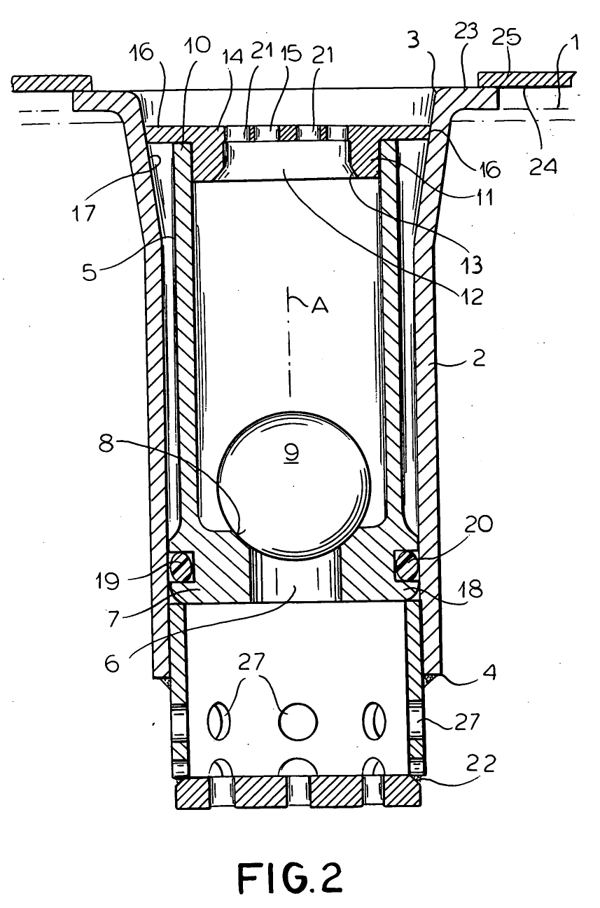

The upper end 3 of the outer tube 2 is formed with a radially outwardly projecting flange 23 secured permanently to a bottom face 24 of the upper floor plate 25. The lower floor plate 26 is dimpled upward around the lower end 4 of the outer tube 2 and fits around it. FIG. 2 shows how a strainer cup 22 formed with an array of throughgoing holes 27 can be fitted into the lower end 4 of the tube 2.

Under normal circumstances the hall 9 site on the lower seat 8 and prevents air from entering or leaving the container through the valve. This is important in a refrigerated container to conserve energy.

Any water an the floor 1 will flow down through the holes 21 and 12 into the inner tube 5 and will float up the ball 9, thereby unblocking the hole 6 so that this liquid can flow out through the hole 6, and through the holes 27 if the strainer 22 is provided. Once the liquid has all drained, the valve-body ball 9 will settle back down in the lower seat 8.

The flow cross section of the hole 6 is smaller than the aggregate or total flow cross section of the strainer holes 27, and greater than the flow cross section of the hole 12 or of the aggregate or total flow cross section of the holes 21. Thus liquid can flow through the holes 27 faster than it can flow through the hole 6, and through the hole 6 faster than through the array of holes 21 or the hole 12. This dimensioning of the holes 6, 8, 21, and 27 ensures that the valve will not fill up when draining from above.

If water backs up downstream of the hole 6 or the bottom of the container having the floor 1 is set in a moderately deep puddle or the like, the ball 9 will float up and fit from below into the seat 13, preventing water from entering the container from below through the valve. Thus the valve according to the invention allows water to drain out of the container, prevents water from getting into the container from below, and also prevents air movement into or out of the container through the valve.

I claim:

1. A drain valve for installation in a floor, the valve comprising:
a generally tubular housing having an open upper end and an open lower end and laterally closed side walls therebetween;
a bottom plate closing lower housing end, formed with a throughgoing lower hole, and formed around the lower hole, with an upwardly directed lower valve seat;
a top plate closing the upper housing end, formed with a throughgoing upper hole, and formed around the respective hole with a downwardly directed upper valve seat; and
a floatable valve body in the hosing between the plates and movable between an upper position fitted in and blocking the upper seat and clear of the lower seat and a lower position fitted in the lower seat and clear of the upper seat, flow only being possible through the housing in an intermediate position of the ball clear of both of the seats.

2. The drain valve defined in cain 1 wherein the housing includes:
an outer tube adapted to be fitted through a floor;
an inner tube engaged coaxially inside the outer tube, carrying the plates, and holding the body; and
means including a seal between the inner tube and outer tube for blocking flow through the valve therebetween.

3. The drain valve defined in claim 2 wherein the inner tube is releasably mounted in the outer tube.

4. The drain valve defined in claim 3 wherein the top plate has a radially projecting rim bearing on an inner surface of the outer tube and forming part of the seal.

5. The drain valve defined in claim 3 wherein the inner tube has a lower end formed with a groove, the valve further comprising
a seal ring set in the groove and bearing outward on an inner surface of the outer tube.

6. The drain valve defined in claim 2 wherein the top wall is a disk snap-fitted to an upper end of the inner tube.

7. The drain valve defined in claim 2 wherein both tubes are laterally closed along their full lengths.

8. The drain valve defined in claim 2 wherein the top plate is formed above the upper hole with a plurality of small-diameter perforations each of substantially smaller flow cross section than the upper hole.

9. The drain valve defined in claim 8 wherein the upper hole has a smaller flow cross section than the lower hole.

10. The drain valve defined in claim 8 wherein the perforations of the upper plate have a smaller aggregate flow cross section than the lower hole.

11. The drain valve defined in claim 1 wherein the valve body is a ball.

12. The drain valve defined in claim 1, further comprising
a strainer fitted over the lower end of the housing.

13. A drain valve for installation in a floor, the valve comprising:
an outer tube adapted to be fitted through a floor;
an inner tube engaged coaxially inside the outer tube and having an upwardly open upper end and a downwardly open lower end and laterally closed side walls therebetween;
means including a seal between the inner tube and outer tuber for blocking flow through the valve therebetween;
a bottom plate closing the lower end, formed with a throughgoing lower hole, and formed around the lower hole with an upwardly directed lower valve seat;
a top plate closing the upper end, formed with a throughgoing upper hole, and formed around the lower hole with an upwardly directed lower valve seat;
a top plate closing the upper end, formed with a throughgoing upper hole, and formed around the respective hole with a downwardly directed upper valve seat; and
a floatable valve body in the housing between the plates and movable between an upper position fitted in and blocking the upper seat and clear of the lower seat and a lower position fitted in the lower seat and clear of the upper seat, flow only being possible through the housing in an intermediate position of the ball clear of both of the seats.
